(19) United States
(12) Patent Application Publication
(10) Pub. No.: US 2006/0161759 A1
(43) Pub. Date: Jul. 20, 2006

(54) Methods and apparatus for memory access within a computer system

(75) Inventors: Philip R. Hillier III, Rochester, MN (US); Joseph A. Kirscht, Rochester, MN (US)

Correspondence Address: Robert Williams;IBM Corporation, Intellectual Property Law Dept. 917, 3605 Hwy. 52 North, Rochester, MN, 55901, US

(73) Assignee: International Business Machines Corporation, Armonk, NY (US)

(21) Appl. No.: 11/035,557

(22) Filed: Jan. 14, 2005

(51) Int. Cl. G06F 12/10

(52) U.S. Cl. 711/202; 711/154

(57) ABSTRACT

In a first aspect, a first method is provided for accessing a main memory. The first method includes the steps of (1) receiving a real address of the main memory that includes critical bits requiring conversion to bits of a physical address to start a memory access in a node including local memory of the main memory, wherein the physical address is a node-specific address; (2) converting the critical bits of the real address to critical bits of a physical address in a time faster than the time required to convert the entire real address to a physical address representing a node-specific memory address; and (3) employing the converted critical bits to start the memory access. Numerous other aspects are provided.

### FIELD OF THE INVENTION

The present invention relates generally to a computer system, and more particularly to methods and apparatus for memory access within the computer system.

### BACKGROUND

A computer system may include a main memory that includes one or more local memories coupled to respective nodes of the computer system. The computer system may receive a request to access memory specifying a real address. To start a memory access, a set of bits (e.g., critical bits) included in the real address must be converted (e.g., normalized) to a physical address (e.g., a node-specific address). However, in some conventional computer systems, the critical bits are unaffected by the conversion. Consequently, the computer systems may extract the critical bits from the real address without waiting for the conversion of the entire real address into a physical address to complete. Therefore, a memory access may start with a low latency.

However, recent memory design changes of computer systems have caused the number of critical bits to increase such that some of the critical bits must be adjusted during conversion. As such, computer system performance may suffer.

Accordingly, improved methods and apparatus for memory access are desirable.

### SUMMARY OF THE INVENTION

In a first aspect of the invention, a first method is provided for accessing a main memory. The first method includes the steps of (1) receiving a real address of the main memory that includes critical bits requiring conversion to bits of a physical address to start a memory access in a node including local memory of the main memory, wherein the physical address is a node-specific address; (2) converting the critical bits of the real address to critical bits of a physical address in a time faster than the time required to convert the entire real address to a physical address representing a node-specific memory address; and (3) employing the converted critical bits to start the memory access.

In a second aspect of the invention, a first apparatus is provided for accessing a main memory. The first apparatus includes a memory controller coupled to local memory of the main memory, thereby defining a node. The memory controller includes logic adapted to (1) receive a real address of the main memory that includes critical bits requiring conversion to bits of a physical address to start a memory access in the node including the local memory of the main memory, wherein the physical address is a node-specific address; (2) convert the critical bits of the real address to critical bits of a physical address in a time faster than the time required to convert the entire real address to a physical address representing a node-specific memory address; and (3) employ the converted critical bits to start the memory access. Numerous other aspects are provided in accordance with these and other aspects of the invention.

Other features and aspects of the present invention will become more fully apparent from the following detailed description, the appended claims and the accompanying drawings.

### BRIEF DESCRIPTION OF THE FIGURES

FIG. 1 is a block diagram of an apparatus including an apparatus for accessing memory in accordance with an embodiment of the present invention.

FIGS. 2A and 2B are a block diagram of the apparatus for accessing memory in accordance with an embodiment of the present invention.

FIG. 3 is a block diagram of fast normalization logic included in the apparatus for accessing memory in accordance with an embodiment of the present invention.

FIG. 4 illustrates a method for accessing memory in accordance with an embodiment of the present invention.

### DETAILED DESCRIPTION

The present invention provides methods and apparatus for accessing memory of a node with low latency without decreasing the granularity with which parameters, such as a memory base offset address, memory hole size and remote cache size for memory may be specified. More specifically, a computer system, server or the like, may be coupled to one or more nodes each of which include memory. The combined memories of such nodes serve as the memory of the computer system. During operation, the computer system may receive a request to access memory identified by a real memory address.

In one or more embodiments of the invention, the computer system adjusts a first portion of the critical portion of the real address that will be affected by the address conversion using a pre-computed value such that the adjusted first portion of the real address reflects the value of the first portion after address conversion. Further, a second portion of the critical portion of the real address (e.g., a portion that will be unaffected by address conversion) is extracted from the real address. The adjusted first portion and extracted second portion of the critical portion of the real address may be combined to form a converted critical portion of the real address. The computer system may adjust the first portion of the critical portion of the real address faster than the time required to convert the entire real address to the physical address. In this manner, the present methods and apparatus enable a low latency memory access based on such a real address. Further, by adjusting the first portion of the critical bits, the present methods and apparatus do not decrease the granularity with which memory holes and the like described above may be accessed. Consequently, the present methods and apparatus facilitate support for larger memory address space without degrading system performance.

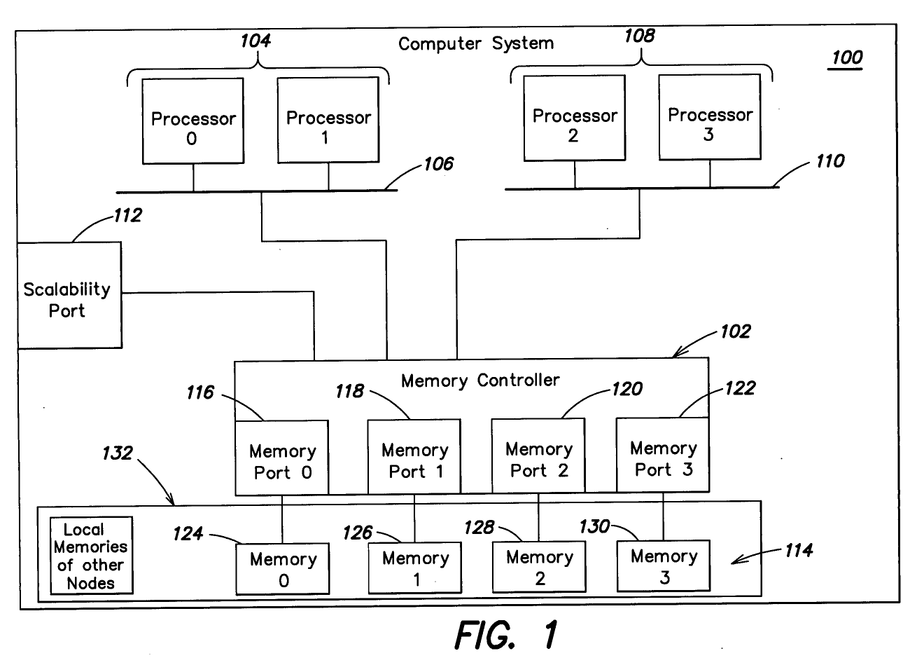

FIG. 1 is a block diagram of an apparatus including an apparatus for accessing memory in accordance with an embodiment of the present invention. With reference to FIG. 1, the apparatus 100 may be a computer system or the like. The apparatus 100 may include a plurality of processors coupled to an apparatus for accessing memory 102 (described below), such as a memory controller, via one or more busses. More specifically, the apparatus 100 may include a first group of one or more processors 104 coupled to the apparatus for accessing memory 102 via a first bus 106 and second group of one or more processors 108 coupled to the apparatus for accessing memory 102 via a second bus 110. Although the first 104 and second groups of one or more processors 108 each include two processors, the first 104 and/or second group of one or more processors 108 may include a larger or smaller number of processors. Further, although the apparatus 100 include two busses, a larger or smaller number of busses may be employed.

The apparatus 100 may include a scalability port 112 coupled to the apparatus for accessing memory 102. The scalability port 112 may be employed for coupling to other apparatus for accessing memory via a scalability network (not shown). The apparatus for accessing memory 102 is adapted to receive requests to access memory from a processor via the first 106 or second bus 110 and/or from the scalability port 112 and provide memory access to such requests.

The apparatus for accessing memory 102 may be coupled to a local memory (e.g., one or more DRAMs) 114, thereby forming a node. More specifically, the apparatus for accessing memory 102 may include a plurality of memory ports (e.g., a first through fourth memory ports 116-122) for coupling to the local memory 114. For example, each memory port 116-122 may couple to a respective memory chip (e.g., DRAM) 124-130 included in the local memory 114. Although the apparatus for accessing memory 102 includes four memory ports, a larger or smaller number of memory ports may be employed. The computer system 100 may include or be coupled to additional nodes. The combination of the respective local memories of all nodes form a main memory 132. The apparatus for accessing memory 102 is adapted to receive requests for memory access and service such requests. While servicing a request, the apparatus for accessing memory 102 may access one or more memory ports 116-122.

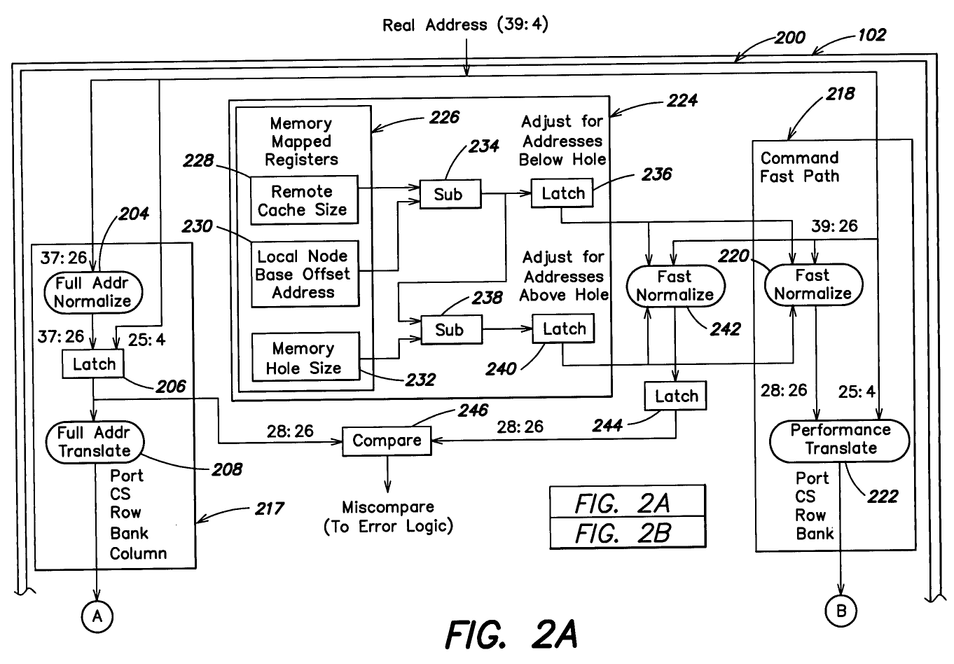

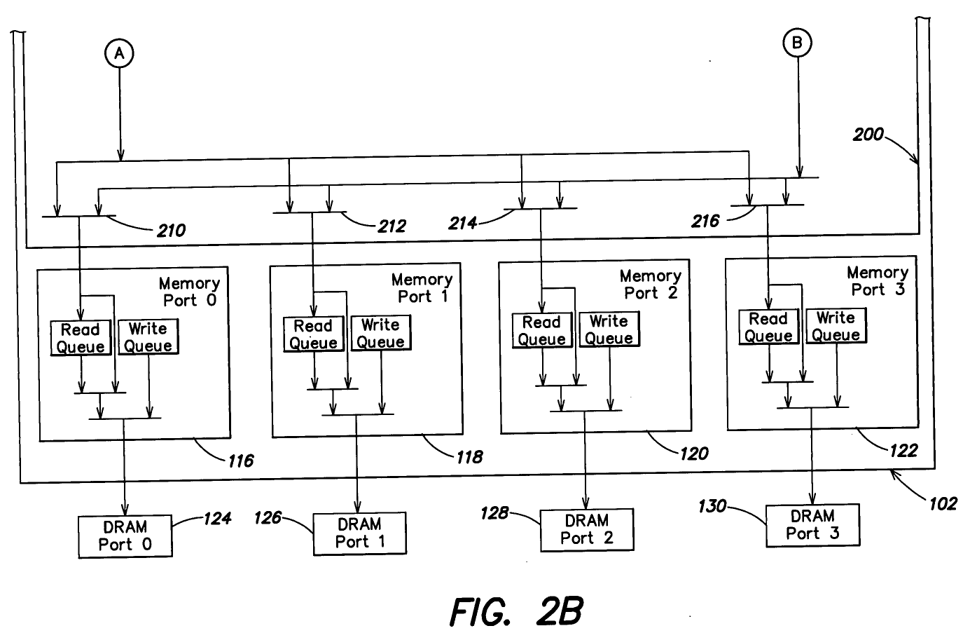

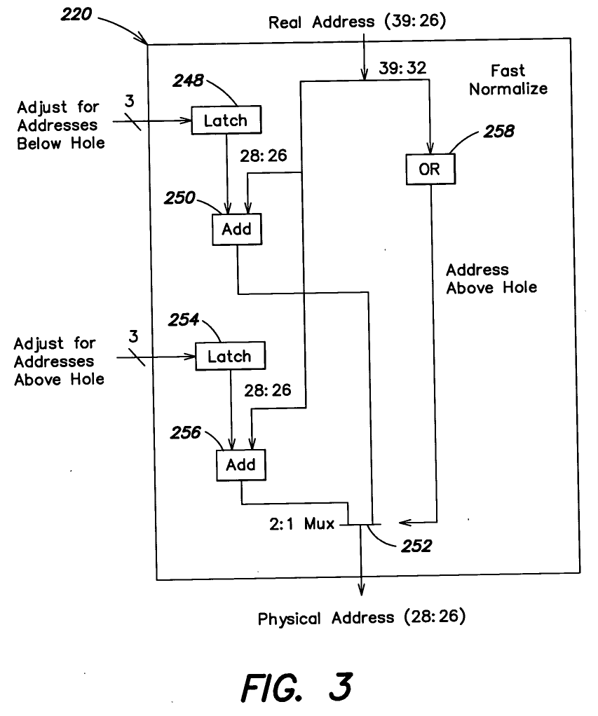

The apparatus for accessing memory 102 may include any suitable combination of logic, registers, memory or the like, and in at least one embodiment may comprise an application specific integrated circuit (ASIC). Details of the apparatus for accessing memory 102 are described below with reference to FIGS. 2 and 3.

FIGS. 2A and 2B are a block diagram of the apparatus for accessing memory in accordance with an embodiment of the present invention. With reference to FIGS. 2A and 2B, the apparatus for accessing memory 102 (e.g., memory controller) includes logic 200 for address translation adapted to receive an address (e.g., a real address) associated with a request and to access memory based on the address. The real address is a system address. More specifically, the real address includes information about a portion of a main memory, which is the combination of the local memory 114 included in each node of the computer system. In some embodiments, the real address includes 40 bits. For example, bit 0-3 of the real address may be unused, bits 4-5 may store the least significant bits indicating a memory column address for bursts of data, bits 6-7 may store a bit indicating a memory internal bank select, bits 8-9 may store bits indicating a memory port, bit 10 may store remaining bits indicating the memory internal bank select, bits 11-19 may store bits indicating a memory row address, bits 20-22 may store bits indicating a memory chip select group, bits 23-28 may store remaining bits of the memory row address and bits 29-37 may store remaining bits indicating the memory column address. However, a larger or smaller number of bits may be employed for any of the fields described above. Further, the real address may include different and/or a larger or smaller number of fields.

A memory port, chip select group, row and internal bank are required to start a memory access. Therefore, bits of the real address (e.g., bits 4-28) for storing such information are critical. According to the present methods and apparatus, a memory design and granularity of parameters associated with such memory design may be employed such that some critical bits of a real address are altered (e.g., normalized) during conversion of the real address into a physical address.

As described below, the apparatus for accessing memory 102 includes logic for converting bits of a real address into corresponding bits of a physical address. To complete a memory access, the entire real address may be converted to a physical memory address. Therefore, the address translation logic 200 includes first normalization logic 204 (e.g., full address normalize logic) adapted to receive a real address as input and convert the real address to a physical address (e.g., node-specific address). For example, the first normalization logic 204 may receive bits 4-39 of a real address, convert such bits of the real address into corresponding bits of a physical address. An output of the first normalization logic 204 is coupled to a first latch 206. The first latch 206 may store the physical address for timing purposes.

Alternatively, the first normalization logic 204 may receive only real address bits that may be affected (e.g., altered) during the conversion of the real address to a physical address. For example, bits 26-37 (some of which are critical bits) of the real address may be input to the first normalization logic 204 for conversion and bits 4-25 of the real address, which may not be affected by the conversion, may be extracted from and/or input (e.g., directly) to the first latch 206. In this manner, the first latch 206 may store a physical address.

An output of the first latch 206 is coupled to first address translation logic 208 (e.g., full address translate logic), which is adapted to convert an entire physical address to a DRAM address. The DRAM address may indicate a port number, chip select group, row, internal bank select and column number associated with memory (e.g., a cacheline) required by the request. Such cacheline is included in one of the DRAMs 124-130 coupled to a respective memory port 116-122 of the apparatus for accessing a memory 102. An output of the first address translation logic 208 may be coupled to one or more of the memory ports 116-122. More specifically, the output of the first address translation logic 208 may be coupled to a first input of each of a plurality of multiplexers 210-216, outputs of which are coupled to the memory ports 116-122, respectively.

In this manner, the apparatus for accessing a memory 102 may define a first data path 217 from which memory may be accessed. However, the first latch 206 in the first data path 217 introduces a delay (e.g., of one or more clock cycles) in the data path that increases memory latency. Therefore, the apparatus for accessing a memory 102 may define a second data path 218 through which a memory access required by the request may start with low latency (e.g., faster than through the first data path 217). The second data path 218 may include second normalization logic 220 (e.g., fast normalize logic) adapted to convert a portion of the critical bits of a real address that may be altered during normalization to corresponding critical bits of a physical address. More specifically, the second normalization logic 220 may receive bits of a real address (e.g., bits 26-39) that may be altered during normalization as input. Such bits may include the portion of the critical bits (e.g., bits 26-28) that may be altered during normalization. Additionally, the second normalization logic 220 may receive one or more adjustment values as input. Based on the above inputs, the second normalization logic 220 is adapted to convert the portion of the critical bits of the real address received as input to corresponding critical bits of a physical address and output such result. For the real address described above, the second normalization logic 220 may output-normalized bits (e.g., critical bits) corresponding to bits 26-28 of the real address. Details of the second normalization logic 220 are described below with reference to FIG. 3.

Further, the second data path 218 may include second address translation logic 222 (e.g., performance translate logic) coupled to an output of the second normalization logic 220. Therefore, the second address translation logic 222 may receive the above-described portion (e.g., bits 26-28) of the critical bits of the physical address as input. Further, the second address translation logic 222 may receive one or more portions of the real address bits (e.g., portions of the critical bits that will be unaffected during conversion of the real address to a physical address) as input. For the real address described above, the second address translation logic 222 may receive another portion of the critical bits (e.g., bits 4-25) of the real address as input. The second address translation logic 222 is adapted to receive such portion of the critical bits (e.g., which represent critical bits of the physical address) as input and convert such bits into corresponding critical bits of a DRAM address. In this manner, the second address translation logic 222 may determine and output information, such as a memory port, chip select group, row and internal bank select, required to start a memory access.

Similar to the first address translation logic 208, an output of the second address translation logic 222 may be coupled to one or more of the memory ports 116-122. More specifically, the output of the second address translation logic 222 may be coupled to a second input of each of the plurality of multiplexers 210-216, outputs of which are coupled to the memory ports 116-122, respectively. Each such multiplexer 210-216 is adapted to selectively output data input by the first or second multiplexer input. For example, based on a control signal (not shown) input by such multiplexer 210-216, the multiplexer 210-216 may output data input by the first or second input to the memory port 116-122 to which the multiplexer 210-216 is coupled.

In this manner, the apparatus for accessing a memory 102 may employ control signals such that during a first time period, information required to start a memory access, which is received by a multiplexer 210-216 from the second address translation logic 222, is output by the multiplexer 210-216 to a respective memory port 116-122. During a subsequent time period, information required to complete the memory access but which may not be necessary to start such access (e.g., a column number to be accessed), which is received by the multiplexer 210-216 from the first address translation logic 208, is output by the multiplexer 210-216 to the respective memory port 116-122. Therefore, according to the present methods and apparatus, a memory access (e.g., a row access or activate) may start without waiting for conversion of all information required to complete such memory access, thereby reducing and/or minimizing memory latency.

Details of the adjustment values referred to above are now described. The logic for accessing a memory 102 may include logic 224 for calculating and/or storing one or more adjustment values. For example, the apparatus for accessing a memory 102 may include one or more registers (e.g., memory mapped registers) 226 for storing one or more parameters associated with the memory. In one embodiment, the apparatus for accessing memory 102 includes three registers (although a larger or smaller number of registers may be employed). For example, the apparatus for accessing a memory 102 may include a first register 228 for storing a remote cache size, which indicates an amount of the local memory 114 employed as a remote cache, a second register 230 for storing a memory base offset address (e.g., local node base offset address), which indicates a starting real address of memory in a corresponding node, and a third register 232 for storing a memory hole size, which indicates a real memory address mapped to a range. The logic 224 may include first subtraction logic 234 respective inputs of which are coupled to the first 228 and second 230 register and an output of which is coupled to a first latch for storing an adjustment value 236. The first subtraction logic 234 is adapted to compute a first adjustment value based on the remote cache size and local node base offset address and store such value in the first latch for storing an adjustment value 236. For example, the logic 234 may be adapted to compute the first adjustment values based on one or more portions (e.g., a subset) of bits indicating the remote cache size and one or more portions (e.g., a subset) of the bits indicating the local node base offset address. The first adjustment value indicates an adjustment that must be made during normalization to the portion of the critical bits of the real address that will be altered during normalization. The first adjustment value is for real addresses below the memory hole. The output of the first latch for storing an adjustment value 236 may be coupled to the second normalization logic 220 described above. In this manner, the logic 224 for calculating and/or storing one or more adjustment values may provide the first adjustment value to the second normalization logic 220 as input.

Similarly, the logic 224 for calculating and/or storing one or more adjustment values may include second subtraction logic 238. Respective inputs of the second subtraction logic 238 may be coupled to an output of the first subtraction logic 234 and the third register 232. An output of the second subtraction logic 238 may be coupled to a second latch for storing an adjustment value 240. The second subtraction logic 238 is adapted to compute a second adjustment value based on the remote cache size, local node base offset address and memory hole size, and store such value in the second latch for storing an adjustment value 240. For example, the second subtraction logic 238 is adapted to compute the second adjustment value based on one or more portions (e.g., a subset) of bits indicating the remote cache size, one or more portions (e.g., a subset) of the bits indicating the local node base offset address and one or more portions (e.g., a subset) of bits indicating a memory hole size. The second adjustment value indicates an adjustment that must be made during normalization to the portion of the critical bits of the real address that will be altered during normalization. The second adjustment value is for real addresses above the memory hole. The output of the second latch for storing an adjustment value 240 may be coupled to the second normalization logic 220. In this manner, the logic 224 for calculating and/or storing one or more adjustment values may provide the second adjustment value to the second normalization logic 220 as input. In some embodiments, the first and/or second adjustment values are three bits wide (although a larger or smaller number of bits may be employed). Further, in some embodiments, the logic 224 for calculating and/or storing one or more adjustment values may compute (e.g., pre-compute) the first and/or second adjustment values before receiving the real address.

The logic 224 for calculating and/or storing one or more adjustment values is exemplary. Therefore, a different configuration of logic 224 for calculating and/or storing one or more adjustment values for portions of critical bits of a real address that will be altered during normalization may be employed. Further, although specific algorithms are described above for calculating the first and second adjustment values, a different algorithm may be employed to calculate the first and/or second adjustment values. In this manner, the first and/or second adjustment values may be based on additional and/or different parameters.

Additionally, in some embodiments, the second normalization logic 220 may be replicated in the apparatus 102 for accessing a memory as third normalization logic 242 (e.g., fast normalize logic), which may be outside of the second data path 218. The third normalization logic 242 may receive the same inputs as the second normalization logic 220. An output of the third normalization logic 242 is coupled to a second latch 244 for storing data output from the third normalization logic 242. The second latch 244 may be employed for timing purposes. In this manner, the third normalization logic 242 may output normalized bits corresponding to critical bits of the real address that may be affected during normalization (e.g., bits 26-28) and store such bits in the second latch 244. Such bits reflect the output of the second normalization logic 220.

Further, the logic 102 for accessing a memory may include compare logic 246 (e.g., external to the second data path 218). Respective inputs of the compare logic 246 are coupled to outputs of the first 206 and second latches 244. The compare logic 246 is adapted to compare data output from the first 206 and second latches 244 and input by the compare logic 246, and output a signal indicating whether such inputs match, for example, to error logic (not shown). In this manner, the logic 102 for accessing a memory may provide error checking and ensure consistency for address conversion performed using the first 217 and second data paths 218.

Details of the second normalization logic 220 are now described with reference to FIG. 3, which is a block diagram of fast normalization logic included in the apparatus for accessing memory in accordance with an embodiment of the present invention. With reference to FIG. 3, the second normalization logic 220 may include a first latch 248 coupled to the first latch for storing an adjustment value 236 of the logic 224. More specifically, an output of the first latch for storing an adjustment value 236 is coupled to an input of the first latch 248 of the second normalization logic 220. The second normalization logic 220 may include first adding logic 250 (e.g., an adder) coupled to an output of the first latch 248. A portion of the real address bits received by the second normalization logic 220 may be provided to the first adding logic 250 as input. For example, the second normalization logic 220 may receive a portion of a real address that will be affected by the normalization (e.g., bits 26-39 for the real address described above). Critical bits included in such portion (e.g., bits 26-28 for the real address described above) may be provided to the first adding logic 250. The first adding logic 250 is adapted to adjust such portion of the critical bits based on the first adjustment values (e.g., by performing fast addition. For example, the first adding logic 250 may adjust such portion of the critical bits by adding such portion of the critical bits to the first adjustment value. An output of the first adding logic 250 may be coupled to a first input of a multiplexer 252 included in the second normalization logic 220.

Similarly, the second normalization logic 220 may include a second latch 254 coupled to the second latch for storing an adjustment value 240 of the logic 224. More specifically, an output of the second latch for storing an adjustment value 240 is coupled to an input of the second latch 254 of the second normalization logic 220. The second normalization logic 220 may include second adding logic 256 (e.g., an adder) coupled to an output of the second latch 254. Similar to the first adding logic 250, a portion of the bits received by the second normalization logic 220 may be provided to the second adding logic 256 as input. For example, the second normalization logic 220 may receive a portion of a real address that will be affected by the normalization (e.g., bits 26-39 for the real address described above). Critical bits included in such portion (e.g., bits 26-28 for the real address described above) may be provided to the second adding logic 256. The second adding logic 256 is adapted to adjust such portion of the critical bits based on the second adjustment values (e.g., by performing fast addition). For example, the second adding logic 256 may adjust such portion of the critical bits by adding the portion of the critical bits to the second adjustment value. An output of the second adding logic 256 may be coupled to a second input of the multiplexer 252 included in the second normalization logic 220.

The multiplexer 252 is adapted to selectively output data input by the first or second input of the multiplexer 252 based on a control (e.g., select) signal input by the multiplexer 252. To create such control signal, the second normalization logic 220 may include logic for performing a logical OR operation 258. The logic for performing a logical OR operation 258 may receive bits (e.g., in parallel with adjusting portions of critical bits as described above) of the real address which may be asserted if such address is above a hole in the memory. For example, because the top of a hole included in memory is typically located at 4 GB, bits 32 and above (e.g., bits 32-39) may indicate whether the real address is below or above the hole. However, in some embodiments, the top of the hole may be located elsewhere (e.g., 2 GB, 8 GB, etc.) and in such embodiments, a larger or smaller number of the bits may indicate whether the real address is below or above the hole. If any of such bits are asserted (e.g., are a logical “1”), the real address is above the memory hole. However, if all such bits are not asserted (e.g., are logical “0”s), the real address is below the memory hole. The logic for performing a logical OR operation 258 is adapted to determine whether any of the bits (e.g., bits input by such logic 258) are asserted, and therefore, the real address is above the hole. If any such bits are asserted, the logic for performing a logical OR operation 258 may output an asserted signal (e.g., a logical “1”). Alternatively, if no such bits are asserted, the logic for performing a logical OR operation 258 may output a signal that is not asserted (e.g., a logical “0”). The signal output by the logic for performing a logical OR operation 258 may be provided by the multiplexer 252 as a control signal.

In this manner, if the second normalization logic 220 determines the real address is above the memory hole, the second normalization logic 220 (e.g., the multiplexer 252 of the second normalization logic) may output critical bit included in a portion of a real address that will be affected by the normalization (e.g., bits 26-28 for the real address described above) adjusted by the first adjustment value. Alternatively, if the second normalization logic 220 determines the real address is below the memory hole, the second normalization logic 220 (e.g., the multiplexer 252 of the second normalization logic) outputs critical bits included in a portion of a real address that will be affected by the normalization (e.g., bits 26-28 for the real address described above) adjusted by the second adjustment value. Such output may serve as bits (e.g., 26-28) of the physical address.

The second normalization logic 220 is exemplary. Therefore, a different configuration of logic for converting a portion of the critical bits of a real address that may be altered during normalization to corresponding critical bits of a physical address may be employed. More specifically, although specific algorithms are described above for converting a portion of the critical bits of a real address that may be altered during normalization to corresponding critical bits of a physical address, a different algorithm may be employed converting the portion of the critical bits of the real address that may be altered during normalization to corresponding critical bits of the physical address. It should be noted that because the first 250 and second latch 254 are near the input of respective adding logic 250, 256 and/or are not in the critical data path, the first 250 and second latches 254 may not insert a logic delay in the second data path 218 like that inserted by latch 206 in the first data path 217.

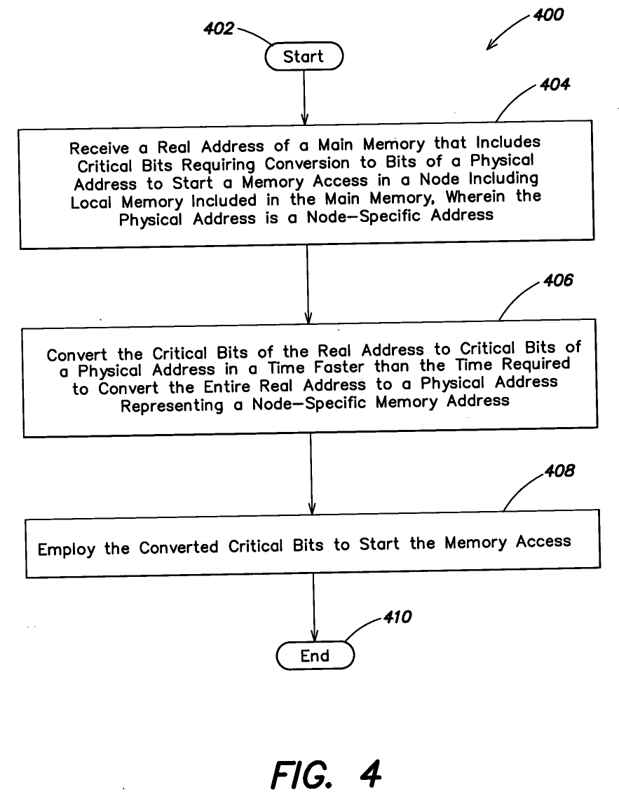

The operation of the apparatus including an apparatus for accessing a memory is now described with reference to FIGS. 1-3 and with reference to FIG. 4 which illustrates a method for accessing a memory in accordance with an embodiment of the present invention. With reference to FIG. 4, in step 402, the method begins. In step 404, a real address of the main memory that includes critical bits requiring conversion to bits of a physical address to start a memory access is received in a node including local memory of the main memory, wherein the physical address is a node-specific address. For example, the apparatus 102 for accessing a memory may receive a real address, for example, bits 4-39 of the 40-bit address described above. The real address may be associated with a request to access memory. Portions of such memory address may be provided to the first 217 and second data paths 218. More specifically, a first portion (e.g., bits 26-37) of the real address may be provided to the first normalization logic 204 and a second portion (e.g., bits 4-25) of the real address may be provided to the first latch 206 in the first data path 217.

Similarly, a first portion (e.g., bits 26-39) of the real address may be provided to the second normalization logic 220 and a second portion (e.g., bits 4-25) of the real address may be provided to the second address translation logic 222 of the second data path 218. Further, one or more adjustment values may be provided to the second normalization logic 220. More specifically, the first and second adjustment values may be provided to the second normalization logic 220. Additionally, the first portion (e.g., bits 26-39) of the real address and the one or more adjustment values may be provided to the third translation logic 242 of the apparatus 102 for accessing a memory.

In step 406, the critical bits of the real address are converted to critical bits of a physical address in a time faster than the time required to convert the entire real address to a physical address representing a node-specific memory address. More specifically, the first normalization logic 204 may convert the first portion (e.g., bits 26-37) of the real address received by the logic 204, which includes a portion of the critical bits (e.g., bits 26-28), to a corresponding portion (e.g., bits 26-37 of a physical address. The first normalization logic 204 outputs such corresponding portion of the physical address to the first latch 206. Further, a second portion (e.g., bits 4-25) of the real address, which may be unaffected by the conversion (e.g., normalization) of the real address to a physical address may be extracted directly from the real address and stored in the first latch 206. However, the above conversion requires time because, in additional to some critical bits (e.g., bits 26-28), the first address normalization logic 204 in the first data path 217 converts non-critical bits (e.g., bits 29-37) and stores such data in the first latch 206. In this manner, the entire real address may be converted to a physical address.

Therefore, second normalization logic 220 converts critical bits (e.g., bits 26-28) of a first portion of the real address to corresponding critical bits (e.g., bits 26-39) of the physical address. More specifically, the second normalization logic 220 may employ the first adjustment value to adjust such critical bits (e.g., bits 26-28) of the first portion of the real address to a first set of corresponding critical bits (e.g., bits 26-28) of the physical address. Alternatively or additionally, the second normalization logic 220 may employ the second adjustment value to adjust the critical bits (e.g., bits 26-28) of the first portion of the real address to a second set of corresponding critical bits (e.g., bits 26-28) of the physical address.

Further, the second normalization logic 220 determines whether the real address received by the apparatus 102 for accessing a memory is above or below a hole included in the memory (e.g., in parallel with adjusting the critical bits as described above). Based on the above determination, the second normalization logic 220 outputs the first or second set of corresponding critical bits (e.g., bits 26-28) of the physical address. More specifically, if the second normalization logic 220 determines the real address received by the apparatus for accessing a memory is below the hole, the second normalization logic 220 may output the first set of corresponding critical bits. Alternatively, if the second normalization logic 220 determines the real address received by the apparatus for accessing a memory is above the hole, the second normalization logic 220 outputs the second set of corresponding critical bits. Such bits of the physical address may be input by (e.g., directly input by) the second address translation logic 222. In this manner, a portion of the critical bits of the real address may be converted to corresponding critical bits of the physical address and provided to the second address translation logic 222.

The second portion (e.g., bits 4-25) of the real address, which may include the remaining critical bits, are directly input to the second address translation logic 222. More specifically, the second portion of the real address may be extracted directly from the real address received by the apparatus 102 for accessing a memory and provided to the second address translation logic 222. In this manner, the corresponding critical bits (e.g., bits 26-28) of the physical address and the extracted second portion (e.g., bits 4-25) of the real address may be combined to form critical bits (e.g., bits 4-28) of the physical address. Because the second normalization logic 220 may not convert non-critical bits (e.g., bits 29-39) of the real address and/or may not store corresponding bits output from the second normalization logic 220 in a latch, the second normalization logic 220 may convert the critical bits of the real address to critical bits of a physical address (e.g., via the second data path 218) in a time faster than the time required to convert (e.g., via the first data path 217) the entire real address to an entire physical address representing a node-specific memory address.

In step 408, the converted critical bits may be employed to start the memory access. For example, the second address translation logic 222 may convert the critical bits (e.g., bits 4-28) of the physical address to corresponding critical bits of a DRAM address, which may indicate the port number, chip select group, row and internal bank select associated with memory (e.g., a cacheline) to which access is required by the request. Such corresponding critical bits (e.g., bits 4-28) of the DRAM address may be employed to start a memory access. For example, such critical bits of the DRAM address may be provided to one or more of the plurality of multiplexers 210-216. A control signal may be applied to the multiplexer 210-216 coupled to the memory port 116-122, which is indicated by the critical bits of the DRAM address, such that the critical bits of the DRAM address are provided to such memory port 116-122.

While the apparatus for accessing a memory starts the memory access via the second data path 218, the conversion of the entire real address to an entire physical address, and then, to an entire DRAM address continues and may complete via the first data path 217, for example, in a subsequent time period (e.g., clock cycle). The entire DRAM address may indicate a port number, chip select group, row, internal bank select and column number associated with memory (e.g., a cacheline) to which access is required by the request. Therefore, in a time period after the memory access starts, such DRAM address may be provided to one or more of the plurality of multiplexers 210-216. A control signal may be applied to the multiplexer 210-216 coupled to the memory port 116-122, which is indicated by the critical bits of the entire DRAM address such that the entire DRAM address, is provided to such memory port 116-122. In this manner, the column number that may be required to complete the memory access may be provided to the memory port 116-122 after the memory access starts. Therefore, the column number from the first data path 217 may be combined with the critical bits from the second data path 218.

Additionally, in some embodiments, compare logic 246 may be employed for comparing critical bits (e.g., bits 26-28) of the physical address corresponding to critical bits (e.g., bits 26-28), which are included in a portion of the real address that is affected during normalization and are computed via the second data path 217, with corresponding critical bits (e.g., bits 26-28) included in the entire physical address computed via the first data path 217. If the above values do not match the compare logic 246 may output an error to error logic included in or coupled to the apparatus 100. In this manner, a fast normalization (e.g., a fast normalization of bits 26-28) similar to that performed by the second data path 218 and received by the compare logic 246 in a first time period may be compared with normalized bits (e.g., the three least significant bits of those affected by normalization) received from the first data path 217 in a subsequent time period.

Thereafter, step 410 may be performed. In step 410, the method 400 ends. Through use of the method 400 of FIG. 4, a memory access may be performed in a computer system that employs memory addresses, which include critical bits that will be affected during conversion (e.g., normalization), without increasing memory latency and/or decreasing the granularity with which parameters (e.g., memory parameters) are provided. For example, the present methods and apparatus calculate and latch static adjusts that may be added to critical bits included in a portion of the real address that is affected by normalization to quickly normalize such critical bits such that a new access to memory may begin without waiting one or more extra clock cycles for normalization of the entire real address to complete. In this manner, a memory access may start in such system before the entire real address in converted to a physical address, (e.g., and therefore, translated to a DRAM address) without requiring a decrease in the granularity with which parameters are specified (e.g., compared to previous systems). In this manner, the present methods and apparatus avoid adverse affects of increased memory latency and/or decreased parameter granularity. Both are important factors in overall system performance. For example, increasing the minimum latency may degrade system performance. Oversizing the memory hole (e.g., due to decreased parameter granularity) may decrease system performance if the amount of physical memory configured is equal to the maximum supported by the operating system in which case, the memory in the hole may not be usable. Oversizing the amount of memory allocated for the remote cache (e.g., due to decreased parameter granularity) may result in less usable physical memory which may degrade system performance. Further, undersizing the amount of memory allocated for the remote cache will also degrade system performance. For example, by undersizing the amount of memory in a node allocated for the remote cache, a read that could have been serviced via such node's memory would have to be serviced by another (e.g., remote) node. The latency of such operation may be three times that of a local memory access.

The foregoing description discloses only exemplary embodiments of the invention. Modifications of the above disclosed apparatus and methods which fall within the scope of the invention will be readily apparent to those of ordinary skill in the art. For instance, in some embodiments, parameters may be specified with a granularity of 64 MB. However, a larger or smaller granularity may be employed. Further, although in some embodiments, a real address may be forty-bits wide and may include twenty-five critical bits, in other embodiments, the real address may be larger or smaller and/or may include a larger or smaller number of critical bits. In such embodiments, the apparatus 102 for accessing a memory may be adjusted accordingly. Although the logic 224 for calculating and/or storing one or more adjustment values is included in the apparatus 102 for accessing a memory, in some embodiments, the logic 224 may be external to the apparatus 102 for accessing a memory.

This invention may be useful in embodiments that employ a memory cacheline size of 64 bytes, a memory bus width of 16 bytes coupled to DRAMs operating in a Burst 4 mode, and which employ a real address of which bits 3:0 may not be used for a memory access, bits 5:4 of which may be used for DRAM column addresses 1:0 for the 4 bursts of data (e.g., while operating in Burst 4 mode). Such embodiments may support a maximum DRAM technology of DDR2 2048Mb. Therefore, three bits of the real address of such embodiments are employed for a bank address, fifteen bits of the real address of such embodiments are employed for a row address and twelve bits of the real address of such embodiments are employed for a column address. Such embodiments may support a maximum of eight chip select groups (e.g., memory extents) for each memory port. Therefore, the three bits of the real address of such embodiments are employed for selecting a memory extent per port. Further, such embodiments may support a maximum of four ports per node in which each node may have processors and a memory controller. Therefore, two bits of the real address of such embodiments may be employed for selecting the memory port. The minimum granularity with which address normalization parameters, such as a local node memory base offset, memory hole size and remote cache size, may be specified in such embodiments may be 64 MB. Therefore, in such embodiments, the local node memory base offset may be specified as 0 to 1 TeraByte in 64 MB increments, the memory hole size may be specified as 0 to 4 GB in 64 MB increments and. remote cache size may be specified as 0 to 256 MB in 64 MB increments.

Therefore, due to the granularity with which normalization parameters may be specified for such embodiments, all critical bits required to start a row address access to the DRAM would need to be specified by bits 25:6 to ensure such bits (e.g., twenty bits) would be unaffected during normalization, and therefore, may be extracted directly from the real address.

However, as described above, such embodiments may include a total of twenty-three critical bits: two bits to specify the memory port, three bits to specify the chip select group (e.g., memory extent) within the memory port, three bits to specify the DRAM internal bank select and fifteen bits to specify the DRAM row address. Consequently, three of the critical bits would have to be extracted from bits above real address bit 25 if the minimum latency is to be maintained. Enabling such extraction in the embodiments would require decreasing the granularity of the address normalization parameters to 512 MB. However, in such embodiments the maximum remote cache size may be only 256 MB and was limited to such value to run in a multi-node system. Therefore, in such embodiments, without a change, the latency would have to increase by one clock cycle to allow the address normalization to complete before extracting the critical bits (e.g., twenty-three critical bits).

The present methods and apparatus solve the problem experienced by such embodiments by providing a fast deterministic address normalization for only the 3 critical bits above bit 25 such that the critical bits could be extracted quickly and still meet the tight timing constraints already imposed by requiring a signal to cross the chip from the front side bus input logic to the memory controller. Although embodiments having a specific configuration, which may benefit from the present methods and apparatus, are described above, embodiments having different configurations may also benefit from the present methods and apparatus.

Accordingly, while the present invention has been disclosed in connection with exemplary embodiments thereof, it should be understood that other embodiments may fall within the spirit and scope of the invention, as defined by the following claims.

The invention claimed is:

1. A method of accessing a main memory, comprising:
receiving a real address of the main memory that includes critical bits requiring conversion to bits of a physical address to start a memory access in a node including local memory of the main memory, wherein the physical address is a node-specific address;
converting the critical bits of the real address to critical bits of a physical address in a time faster than the time required to convert the entire real address to a physical address representing a node-specific memory address; and
employing the converted critical bits to start the memory access.

2. The method of claim 1 further comprising converting the critical bits of the physical address to critical bits of a DRAM address, wherein a DRAM address includes information required to access a port, chip select, row, internal bank and column of the local memory.

3. The method of claim 2 further comprising:
separately converting the entire real address to an entire physical address;
separately converting the entire physical address to an entire DRAM address, wherein the entire DRAM address includes information required to access a port, chip select, row, internal bank and column of the local memory; and
after starting a memory access, combining the information required to access a column of the local memory from the entire DRAM address with the critical bits of the DRAM address.

4. The method of claim 1 wherein converting the critical bits of the real address to critical bits of the physical address in a time faster than the time required to convert the entire real address to a physical address includes:
extracting a first portion of the critical bits from the real address;
converting a second portion of the critical bits from the real address to corresponding bits of the physical address; and
combining the extracted first portion of the critical bits with the converted second portion of the critical bits, thereby forming the converted critical bits of the physical address.

5. The method of claim 4 further comprising:
separately converting the entire real address to an entire physical address; and
comparing the critical bits of the physical address with corresponding bits of the entire physical address to determine whether an error occurred while converting the critical bits of the real address to critical bits of the physical address.

6. The method of claim 4 wherein:
converting the critical bits of the real address to critical bits of a physical address in a time faster than the time required to convert the entire real address to a physical address representing a node-specific memory address includes adding a pre-computed adjustment value to the second portion of the critical bits; and
the pre-computed adjustment value is based at least on a size of local memory employed as a remote cache and a base offset address of the local memory.

7. The method of claim 6 wherein the pre-computed adjustment value is based at least on a subset of bits indicating a size of local memory employed as a remote cache and subset of bits indicating a base offset address of the local memory that corresponds to bits of the second portion of the critical bits.

8. The method of claim 6 further comprising, before receiving the real address, computing the adjustment value based at least on a size of local memory employed as a remote cache and a base offset address of the local memory.

9. The method of claim 6 wherein adding the pre-computed adjustment value to the second portion of the critical bits includes:
adding a first pre-computed adjustment value to the second portion of the critical bits to yield a first adjusted second portion of the critical bits;
adding a second pre-computed adjustment value to the second portion of the critical bits to yield a second adjusted second portion of the critical bits; and
employing the first or second adjusted second portion of the critical bits as the converted critical bits;
wherein the first pre-computed adjustment value is based on a size of local memory employed as a remote cache and a base offset address of the local memory and the second pre-computed adjustment value is based on the size of local memory employed as the remote cache, the base offset address of the local memory and a size of a memory hole included in the main memory.

10. The method of claim 9 wherein employing the first or second adjusted second portion of the critical bits as the converted critical bits includes:
employing the first adjusted second portion of the critical bits as the converted critical bits if the real address is located above the memory hole; and
employing the second adjusted second portion of the critical bits as the converted critical bits if the real address is located below the memory hole.

11. The method of claim 1 wherein the granularity with which at least one of a size of local memory employed as a remote cache, a base offset address of the local memory and a size of a memory hole included in the main memory are specified is not decreased.

12. An apparatus for accessing a main memory, comprising:
a memory controller coupled to local memory of the main memory, thereby defining a node;
wherein the memory controller includes logic adapted to:
receive a real address of the main memory that includes critical bits requiring conversion to bits of a physical address to start a memory access in the node including the local memory of the main memory, wherein the physical address is a node-specific address;
convert the critical bits of the real address to critical bits of a physical address in a time faster than the time required to convert the entire real address to a physical address representing a node-specific memory address; and
employ the converted critical bits to start the memory access.

13. The apparatus of claim 12 wherein the logic is further adapted to convert the critical bits of the physical address to critical bits of a DRAM address, wherein a DRAM address includes information required to access a port, chip select, row, internal bank and column of the local memory.

14. The apparatus of claim 13 wherein the logic is further adapted to:
separately convert the entire real address to an entire physical address;
separately convert the entire physical address to an entire DRAM address, wherein the entire DRAM address includes information required to access a port, chip select, row, internal bank and column of the local memory; and
after starting a memory access, combine the information required to access a column of the local memory from the entire DRAM address with the critical bits of the DRAM address.

15. The apparatus of claim 12 wherein the logic is further adapted to:
extract a first portion of the critical bits from the real address;
convert a second portion of the critical bits from the real address to corresponding bits of the physical address; and
combine the extracted first portion of the critical bits with the converted second portion of the critical bits, thereby forming the converted critical bits of the physical address.

16. The apparatus of claim 15 wherein the logic is further adapted to:
separately convert the entire real address to an entire physical address; and
compare the critical bits of the physical address with corresponding bits of the entire physical address to determine whether an error occurred while converting the critical bits of the real address to critical bits of the physical address.

17. The apparatus of claim 15 wherein:
the logic is further adapted to add a pre-computed adjustment value to the second portion of the critical bits; and
the pre-computed adjustment value is based at least on a size of local memory employed as a remote cache and a base offset address of the local memory.

18. The apparatus of claim 17 wherein the pre-computed adjustment value is based at least on a subset of bits indicating a size of local memory employed as a remote cache and subset of bits indicating a base offset address of the local memory that corresponds to bits of the second portion of the critical bits.

19. The apparatus of claim 17 wherein the logic is further adapted to, before receiving the real address, computing the adjustment value based at least on a size of local memory employed as a remote cache and a base offset address of the local memory.

20. The apparatus of claim 17 wherein the logic is further adapted to:
add a first pre-computed adjustment value to the second portion of the critical bits to yield a first adjusted second portion of the critical bits;
add a second pre-computed adjustment value to the second portion of the critical bits to yield a second adjusted second portion of the critical bits; and
employ the first or second adjusted second portion of the critical bits as the converted critical bits;
wherein the first pre-computed adjustment value is based on a size of the local memory employed as a remote cache and a base offset address of the local memory and the second pre-computed adjustment value is based on the size of the local memory employed as the remote cache, the base offset address of the local memory and a size of a memory hole included in the main memory.

21. The apparatus of claim 20 wherein the logic is further adapted to:
employ the first adjusted second portion of the critical bits as the converted critical bits if the real address is located above the memory hole; and
employ the second adjusted second portion of the critical bits as the converted critical bits if the real address is located below the memory hole.

22. The apparatus of claim 12 wherein the logic is adapted to not decrease the granularity with which at least one of a size of local memory employed as a remote cache, a base offset address of the local memory and a size of a memory hole included in the main memory is specified.
